(19) United States
(12) Patent Application Publication
(10) Pub. No.: US 2024/0084170 A1
(43) Pub. Date: Mar. 14, 2024

(54) POLISHING COMPOSITION AND POLISHING METHOD

(71) Applicant: FUJIMI INCORPORATED, Aichi (JP)

(72) Inventors: Hiroyuki Ishida, Aichi (JP); Hitoshi Morinaga, Aichi (JP)

(21) Appl. No.: 18/284,689

(22) PCT Filed: Jan. 26, 2022
(86) PCT No.: PCT/JP2022/002881

§ 371 Date: Sep. 28, 2023

(30) Foreign Application Priority Data
Mar. 30, 2021 (JP) 2021-057427

(51) Int. Cl. C09G 1/02

(52) U.S. Cl. CPC C09G 1/02

(57) ABSTRACT

Provided is a polishing composition that enables polishing a resin object to be polished at a high polishing removal rate and enables polishing the surface of a resin object to be polished into a flat and smooth surface. The polishing composition includes abrasives, a surfactant, and water, and the surfactant includes an acetylene compound having a carbon-carbon triple bond and represented by Chemical Formula (1). In Chemical Formula (1), R¹, R², R³, and R⁴ are each independently a hydrogen atom or a substituted or unsubstituted alkyl group having 1 or more and 20 or less carbon atoms; R⁵ and R⁶ are each independently a substituted or unsubstituted alkylene group having 1 or more and 5 or less carbon atoms; m is an integer of 1 or more; n is an integer of 0 or more; and m+n is 50 or less. The polishing composition is used to polish a resin object to be polished.

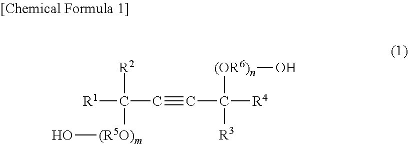

### TECHNICAL FIELD

The present invention relates to a polishing composition and a polishing method.

### BACKGROUND ART

A polishing composition used to polish the surface of a resin object to be polished is required to have a performance of quickly polishing an object to be polished (i.e., a high polishing removal rate) and a performance of polishing the surface of an object to be polished into a flat and smooth surface.

### CITATION LIST

### Patent Literature

PTL 1: WO 2020/122191

### SUMMARY OF INVENTION

### Technical Problem

For example, PTL 1 discloses a polishing composition meeting the above requirements. Polishing compositions used to polish the surface of a resin object to be polished are, however, required to have a higher performance of quickly polishing an object to be polished and a higher performance of polishing the surface of an object to be polished into a flat and smooth surface.

The present invention is intended to provide a polishing composition and a polishing method enabling polishing a resin object to be polished at a high polishing removal rate and enabling polishing the surface of a resin object to be polished into a flat and smooth surface.

### Solution to Problem

A polishing composition according to an aspect of the present invention is a polishing composition used to polish a resin object to be polished. The polishing composition includes abrasives, a surfactant, and water. The surfactant includes an acetylene compound having a carbon-carbon triple bond and represented by Chemical Formula (1). In Chemical Formula (1), R¹, R², R³, and R⁴ are each independently a hydrogen atom or a substituted or unsubstituted alkyl group having 1 or more and 20 or less carbon atoms; R⁵ and R⁶ are each independently a substituted or unsubstituted alkylene group having 1 or more and 5 or less carbon atoms; m is an integer of 1 or more; n is an integer of 0 or more; and m+n is 50 or less.

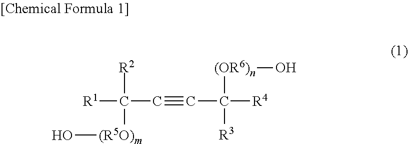

A polishing method according to another aspect of the present invention includes polishing a resin object to be polished with the polishing composition according to the above aspect.

### Advantageous Effects of Invention

According to the present invention, a resin object to be polished can be polished at a high polishing removal rate, and the surface of a resin object to be polished can be polished into a flat and smooth surface.

### DESCRIPTION OF EMBODIMENTS

An embodiment of the present invention will be described in detail. The following embodiments are merely examples of the present invention, and the invention is not limited to the embodiments. Various modifications or improvements can be added to the following embodiments, and the invention can also include such variously modified or improved forms.

A polishing composition according to the present embodiment is a polishing composition used to polish a resin object to be polished and includes abrasives, a surfactant, and water. The surfactant includes an acetylene compound having a carbon-carbon triple bond. The acetylene compound is a compound represented by Chemical Formula (1). In Chemical Formula (1), R¹, R², R³, and R⁴ are each independently a hydrogen atom or a substituted or unsubstituted alkyl group having 1 or more and 20 or less carbon atoms, and R⁵ and R⁶ are each independently a substituted or unsubstituted alkylene group having 1 or more and 5 or less carbon atoms. m is an integer of 1 or more, n is an integer of 0 or more, and m+n is 50 or less.

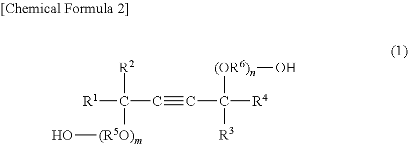

A polishing method according to the present embodiment is a polishing method including polishing a resin object to be polished with the polishing composition according to the above embodiment.

The polishing composition according to the embodiment has an excellent performance of quickly polishing a resin object to be polished and has an excellent performance of polishing the surface of a resin object to be polished into a flat and smooth surface. Hence, by polishing a resin object to be polished with the polishing composition according to the embodiment, the resin object to be polished can be polished at a high polishing removal rate, and the surface of the resin object to be polished can be polished into a flat and smooth surface. Accordingly, a resin product having a flat and smooth surface (for example, having a small surface roughness Ra or having a few defects such as scratches) can be efficiently produced.

The polishing composition and the polishing method according to the embodiments will now be described in detail.

1. Object to be Polished

The object to be polished to which the polishing composition and the polishing method according to the embodiment are applied may be any type that is formed from a resin and may be a part entirely formed from a resin (resin part) or a part partially formed from a resin. Examples of the part partially formed from a resin include a part in which the surface of a base material is coated with a resin coating.

The resin may be any type, and examples include a thermoplastic resin and a thermosetting resin. Examples of the thermoplastic resin include a fluorocarbon resin, an acrylic resin (such as polymethyl acrylate and polymethyl methacrylate), polycarbonate, polyimide, polyamide, polyamide-imide, polystyrene, polyvinyl chloride, polyethylene, polypropylene, an acrylonitrile-butadiene-styrene copolymer, an acrylonitrile-styrene copolymer, polyvinyl alcohol, polyvinylidene chloride, polyethylene terephthalate, polybutylene terephthalate, polyacetal, polyphenyl ether, polysulfone, polyethersulfone, polyphenyl sulfide, polyarylate, polyetherimide, polyether ether ketone, a liquid crystal polymer, an ultra-high-molecular-weight polyethylene, and a urethane resin.

Examples of the fluorocarbon resin include a fully fluorinated resin such as polytetrafluoroethylene (PTFE), a partially fluorinated resin such as polychlorotrifluoroethylene (PCTFE), polyvinylidene fluoride (PVDF), and polyvinyl fluoride (PVF), and a fluorinated resin copolymer such as a perfluoroalkoxy fluorocarbon resin (PFA), a tetrafluoroethylene-hexafluoropropylene copolymer (FEP), an ethylene-tetrafluoroethylene copolymer (ETFE), and an ethylene-chlorotrifluoroethylene copolymer (ECTFE).

Examples of the thermosetting resin include a phenol resin, a urea resin, a melamine resin, an unsaturated polyester, an epoxy resin, a silicon resin, and polyurethane.

The polishing composition and the polishing method according to the embodiments are particularly preferably used to polish, of these resins, a fluorocarbon resin, an acrylic resin, or polycarbonate.

2. Surfactant

The polishing composition according to the embodiment includes a surfactant, and the surfactant includes an acetylene compound represented by Chemical Formula (1). The acetylene compound represented by Chemical Formula (1) functions to hydrophilize the surface of a resin and to reduce the contact angle. As a result, a larger amount of the polishing composition adheres to the surface of a resin object to be polished and a polishing pad, and accordingly the object to be polished can be polished at a high polishing removal rate. In addition, the polishing composition uniformly adheres to the surface of a resin object to be polished, and thus the surface of the object to be polished is likely to be uniformly polished. Accordingly, the surface of the object to be polished can be polished into a flat and smooth surface.

Such advantageous effects are thought to be achieved as follows: the acetylene compound adsorbs to abrasives, a resin object to be polished, and a polishing pad and functions as a binder among the abrasives, the resin object to be polished, and the polishing pad. The mechanism of achieving the advantageous effects is a speculation. The present invention is not limited to the above mechanism.

Hence, when the polishing composition according to the embodiment is used to polish even a highly water repellent resin having a contact angle of 90° or more, the acetylene compound represented by Chemical Formula (1) functions to hydrophilize the resin surface, and the contact angle becomes less than 90°. Accordingly, a highly water repellent resin object to be polished can be polished at a high polishing removal rate, as well as the surface of a highly water repellent resin object to be polished can be polished into a flat and smooth surface. Examples of the highly water repellent resin include the fluorocarbon resins described above.

Needless to say, the polishing composition according to the embodiment is also applicable to a low water repellent resin having a contact angle of less than 90°. The polishing composition can polish a low water repellent resin object to be polished at a high polishing removal rate and can polish the surface of a low water repellent resin object to be polished into a flat and smooth surface.

The acetylene compound represented by Chemical Formula (1) preferably reduces the resin contact angle by 10° or more and 55° or less and more preferably reduces the resin contact angle by 10° or more and 45° or less. When an object to be polished is a highly water repellent resin, the acetylene compound represented by Chemical Formula (1) more preferably reduces the resin contact angle by 20° or more and 45° or less.

The polishing composition according to the embodiment is also applicable to a resin having low hardness and high elasticity or a soft and tough resin. The polishing composition can polish a resin object to be polished having low hardness and high elasticity at a high polishing removal rate and can polish the surface of a resin object to be polished having low hardness and high elasticity into a flat and smooth surface.

In the description, a resin having low hardness means a resin having a Rockwell hardness HRM of 65 or less in accordance with JIS K7202-2. “HR” in “HRM” represents Rockwell hardness, and “M” represents the scale of hardness. A resin having high elasticity means a resin having a tensile elastic modulus of 2.8 GPa or less.

Specific examples of the resin having low hardness and high elasticity include polycarbonate (an HRM of 56, a tensile elastic modulus of 2.1 GPa), an epoxy resin (an HRM of 45, a tensile elastic modulus of 2.2 GPa), and polytetrafluoroethylene (an HRM of 19, a tensile elastic modulus of 0.6 GPa).

The acetylene compound represented by Chemical Formula (1) preferably has an HLB value of 4 or more and 19 or less, more preferably 7 or more and 18 or less, and even more preferably 10 or more and 18 or less. An acetylene compound having an HLB value within the range can achieve a high polishing removal rate and can yield a polished object having a flatter and smoother surface. An acetylene compound having an HLB value of 4 or more is easily dispersed in water, and an acetylene compound having an HLB value of 10 or more is easily dissolved in water.

The acetylene compound represented by Chemical Formula (1) particularly preferably has an HLB value of 10 or more and 15 or less. When the HLB value is within the range, a high polishing removal rate can be achieved, and a polished object has a flatter and smoother surface. In addition, the polishing composition is prevented from foaming, and the polishing composition is easily handled.

As apparent from Chemical Formula (1), the acetylene compound represented by Chemical Formula (1) is an acetylene glycol compound having one acetylene group in a molecule and having alkylene oxides added. As the acetylene compound represented by Chemical Formula (1), a nonionic compound is more preferred from the viewpoint of polishing the surface of an object to be polished into a flat and smooth surface. Acetylene compounds represented by Chemical Formula (1) may be used singly or in combination of two or more of them.

In Chemical Formula (1), R¹, R², R³, and R⁴ are each independently a hydrogen atom or a substituted or unsubstituted alkyl group having 1 or more and 20 or less carbon atoms. The alkyl group may have 1 or more carbon atoms, 2 or more carbon atoms, or 3 or more carbon atoms and may have 20 or less carbon atoms, 18 or less carbon atoms, 16 or less carbon atoms, 15 or less carbon atoms, 12 or less carbon atoms, 10 or less carbon atoms, or 8 or less carbon atoms.

Specific examples of the alkyl group include a methyl group, an ethyl group, a propyl group, an iso-propyl group, a butyl group, an iso-butyl group, a sec-butyl group, a tert-butyl group, a pentyl group, an iso-pentyl group, a neo-pentyl group, a tert-pentyl group, a hexyl group, an octyl group, a nonyl group, a decyl group, a lauryl group, a myristyl group, a palmityl group, and a stearyl group. R¹, R², R³, and R⁴ may all be the same, some may be the same and the others may be different, or all may be different.

In Chemical Formula (1), R⁵ and R⁶ are each independently a substituted or unsubstituted alkylene group having 1 or more and 5 or less carbon atoms. The alkylene group may have 1 or more carbon atoms, 2 or more carbon atoms, or 3 or more carbon atoms and may have 4 or less carbon atoms or 3 or less carbon atoms. Specific examples of the alkylene group include an ethylene group, a propylene group, a butylene group, and a pentylene group. R⁵ and R⁶ may be the same or different.

In Chemical Formula (1), m is an integer of 1 or more, n is an integer of 0 or more, and m+n is 50 or less. m+n may be 1 or more, 3 or more, 5 or more, 10 or more, 15 or more, or 20 or more and may be 50 or less, or less, 22 or less, 16 or less, 12 or less, 8 or less, or 4 or less (for example, 3 or less). m and n may be the same or different.

The acetylene compound represented by Chemical Formula (1) has m pieces of R⁵s in a molecule, but the m pieces of R⁵s may all be the same alkylene group or may be multiple types of alkylene groups. For example, R⁵s may be an ethylene group and a propylene group. In the case, the sum of the number of ethylene groups and the number of propylene groups of R⁵s is m.

The same is applied to R⁶. In other words, the acetylene compound represented by Chemical Formula (1) has n pieces of R⁶s in a molecule, but the n pieces of R⁶s may all be the same alkylene group or may be multiple types of alkylene groups. For example, R⁶s may be an ethylene group and a propylene group. In the case, the sum of the number of ethylene groups and the number of propylene groups of R⁶s is n.

When the acetylene compound represented by Chemical Formula (1) is produced, it is difficult to accurately control m and n. Accordingly, production of the acetylene compound represented by Chemical Formula (1) typically yields a mixture of multiple types of acetylene compounds different in the numerical value of m+n. Hence, the polishing composition according to the embodiment may contain multiple types of acetylene compounds represented by Chemical Formula (1).

The polishing composition according to the embodiment may contain an acetylene compound represented by Chemical Formula (1) in which both m and n are 0.

In Chemical Formula (1), the average numerical value of m+n (average addition molar number) may be 1 or more, 3 or more, 5 or more, 10 or more, 15 or more, or 20 or more and may be 50 or less, 30 or less, 22 or less, 16 or less, 12 or less, 8 or less, or 4 or less (for example, 3 or less).

Specifically preferred examples of the acetylene compound represented by Chemical Formula (1) include an acetylene compound represented by Chemical Formula (2). The acetylene compound represented by Chemical Formula (2) is a compound represented by Chemical Formula (1) in which R¹ and R⁴ are each an isobutyl group, R² and R³ are each a methyl group, and R⁵ and R⁶ are each an ethylene group. p in Chemical Formula (2) is identical with m in Chemical Formula (1), and q in Chemical Formula (2) is identical with n in Chemical Formula (1).

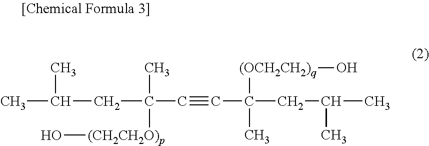

The acetylene compound represented by Chemical Formula (1) may have any molecular weight but preferably has such a molecular weight that the acetylene compound can sufficiently exert the action in the polishing composition. The acetylene compound represented by Chemical Formula (1) may have a molecular weight of, for example, 250 or more, 300 or more, 400 or more, 500 or more, 700 or more, 1,200 or more, or 1,500 or more. The acetylene compound represented by Chemical Formula (1) may have a molecular weight of, for example, 3,000 or less, 2,000 or less, 1,400 or less, 1,000 or less, or 600 or less. As the molecular weight of the acetylene compound represented by Chemical Formula (1), a molecular weight calculated from the chemical formula is adopted.

The content of the acetylene compound represented by Chemical Formula (1) in the polishing composition according to the embodiment is preferably 0.001% by mass or more, more preferably 0.005% by mass or more, and even more preferably 0.01% by mass or more from the viewpoint of achieving the addition effect of the acetylene compound represented by Chemical Formula (1).

The content of the acetylene compound represented by Chemical Formula (1) in the polishing composition according to the embodiment is preferably 0.2% by mass or less, more preferably 0.15% by mass or less, even more preferably 0.1% by mass or less, and particularly preferably 0.09% by mass or less from the viewpoint of cleanability or the like of the acetylene compound represented by Chemical Formula (1).

Accordingly, the content of the acetylene compound represented by Chemical Formula (1) in the polishing composition according to the embodiment is preferably 0.001% by mass or more and 0.2% by mass or less, more preferably 0.005% by mass or more and 0.15% by mass or less, even more preferably 0.01% by mass or more and 0.1% by mass or less, and particularly preferably 0.01% by mass or more and 0.09% by mass or less.

The content of the acetylene compound represented by Chemical Formula (1) in the polishing composition according to the embodiment is preferably applicable, for example, to the content of a polishing liquid (working slurry) supplied to an object to be polished.

The surfactant contained in the polishing composition according to the embodiment may be composed of only the acetylene compound represented by Chemical Formula (1) but may include the acetylene compound represented by Chemical Formula (1) and an additional type of surfactant. As the additional type of surfactant, any of an anionic surfactant, a cationic surfactant, an amphoteric surfactant, and a nonionic surfactant can be used.

Specific examples of the anionic surfactant include polyoxyethylene alkyl ether acetic acid, polyoxyethylene alkyl sulfate, alkyl sulfate, polyoxyethylene alkyl sulfuric acid, alkyl sulfuric acid, alkylbenzene sulfonic acid, alkyl phosphate, polyoxyethylene alkyl phosphate, polyoxyethylene sulfosuccinic acid, alkyl sulfosuccinic acid, alkyl naphthalenesulfonic acid, alkyl diphenyl ether disulfonic acid, and salts of them.

Specific examples of the cationic surfactant include an alkyltrimethylammonium salt, an alkyldimethylammonium salt, an alkylbenzyldimethylammonium salt, and an alkylamine salt.

Specific examples of the amphoteric surfactant include alkylbetaine and alkylamine oxide.

Specific examples of the nonionic surfactant include polyoxyethylene alkyl ether, polyoxyalkylene alkyl ether, sorbitan fatty acid ester, glycerol fatty acid ester, polyoxyethylene fatty acid ester, polyoxyethylene alkylamine, and alkyl alkanolamide.

3. Abrasives

The abrasives included in the polishing composition according to the embodiment may be any type. For example, particles of a metal oxide such as alumina (Al₂O₃), silica (SiO₂), cerium oxide (CeO₂), zirconia (ZrO₂), titania (TiO₂), iron oxide (FeO, Fe₃O₄, Fe₂O₃), and manganese oxide (MnO, Mn₃O₄, Mn₂O₃, MnO₂) can be used. Of these types of abrasives, alumina and silica are preferred, and alumina is more preferred.

The alumina may be any type, and examples include α-alumina, δ-alumina, θ-alumina, κ-alumina, and amorphous alumina. When α-alumina is used, the α-fraction is not specifically limited but is preferably 30% or more, more preferably 40% or more, and even more preferably 50% or more. When α-alumina is used, the α-fraction is 100% or less, preferably 99% or less, and more preferably 97% or less. Within the range, a high polishing removal rate can be achieved while a good surface flatness is maintained. The α-fraction can be determined from the integrated intensity ratio of the (113) plane diffraction line in an X-ray diffraction analysis.

The silica may be any type, and examples include colloidal silica, fumed silica, sol-gel silica, and precipitated silica.

These types of abrasives may be used singly or in combination of two or more of them.

The particle diameter of the abrasives included in the polishing composition according to the embodiment is not specifically limited but is preferably in the following range.

The 50% particle diameter (secondary particle diameter at a cumulative value of 50% from the small particle diameter side, hereinafter also called “D50”) of the abrasives in the volume-based cumulative particle diameter distribution is not specifically limited. When the abrasives are alumina, the 50% particle diameter is preferably 0.1 μm or more, more preferably 0.15 μm or more, and even more preferably 0.2 μm or more from the viewpoint of polishing removal rate. When the abrasives are silica, the D50 is preferably 0.05 μm or more, more preferably 0.1 μm or more, and even more preferably 0.15 μm or more.

When the abrasives are alumina, the D50 of the abrasives is preferably 5 μm or less, may be 4 μm or less, 3 μm or less, or 1.5 μm or less, and is more preferably 1 μm or less, even more preferably 0.5 μm or less, and particularly preferably 0.3 μm or less from the viewpoint of surface properties of a polished object (i.e., surface flatness or smoothness). When the abrasives are silica, the D50 is preferably 1 μm or less, may be 0.5 μm or less, and is more preferably 0.3 μm or less, even more preferably 0.25 μm or less, and particularly preferably 0.2 μm or less. In the present invention, the volume-based cumulative particle diameter distribution is determined by using a laser diffraction scattering particle diameter distribution analyzer.

The 10% particle diameter (secondary particle diameter at a cumulative value of 10% from the small particle diameter side, hereinafter also called “D10”) of the abrasives in the volume-based cumulative particle diameter distribution is not specifically limited. When the abrasives are alumina, the 10% particle diameter is preferably 0.05 μm or more, more preferably 0.1 μm or more, and even more preferably 0.15 or more. When the abrasives are alumina, the D10 is preferably 1 μm or less, more preferably 0.7 μm or less, even more preferably 0.5 μm or less, still more preferably 0.3 μm or less, particularly preferably 0.25 μm or less, and most preferably 0.2 μm or less. When abrasives having a D10 within the range are used, a polished object has a flatter and smoother surface.

The 90% particle diameter (secondary particle diameter at a cumulative value of 90% from the small particle diameter side, hereinafter also called “D90”) of the abrasives in the volume-based cumulative particle diameter distribution is not specifically limited. When the abrasives are alumina, the 90% particle diameter is preferably 0.15 μm or more, more preferably 0.2 μm or more, even more preferably 0.25 or more, and particularly preferably 0.3 μm or more. When abrasives having a D90 within the range are used, a high polishing removal rate can be achieved.

When the abrasives are alumina, the D90 is preferably 8 μm or less, more preferably 3 μm or less, even more preferably 2 μm or less, still more preferably 1 μm or less, further preferably 0.6 μm or less, particularly preferably 0.5 μm or less, and most preferably 0.4 μm or less. When abrasives having a D90 within the range are used, a polished object has a flatter and smoother surface.

The ratio of D90 to D50 (D90/D50) of the abrasives is preferably 1.1 or more and more preferably 1.2 or more when the abrasives are alumina. When the D90/D50 is within the range, a high polishing removal rate can be achieved. The D90/D50 is preferably 2.5 or less, more preferably 1.7 or less, and even more preferably 1.5 or less when the abrasives are alumina. When the D90/D50 is within the range, a polished object has a flatter and smoother surface.

The ratio of D90 to D10 (D90/D10) of the abrasives is preferably 1.2 or more, more preferably 1.3 or more, even more preferably 1.5 or more, and particularly preferably 1.7 or more when the abrasives are alumina. When the D90/D10 is within the range, a high polishing removal rate can be achieved. The D90/D10 is preferably 6.5 or less, more preferably 3.0 or less, even more preferably 2.5 or less, and particularly preferably 2.1 or less when the abrasives are alumina. When the D90/D10 is within the range, a polished object has a flatter and smoother surface.

The ratio of D50 to D10 (D50/D10) of the abrasives is preferably 1.1 or more and more preferably 1.2 or more when the abrasives are alumina. When the D50/D10 is within the range, a high polishing removal rate can be achieved. The D50/D10 is preferably 2.0 or less, more preferably 1.8 or less, and even more preferably 1.6 or less when the abrasives are alumina. When the D50/D10 is within the range, a polished object has a flatter and smoother surface.

The abrasives may have any BET specific surface area. When the abrasives are alumina, the BET specific surface area is preferably 5 m²/g or more, more preferably 10 m²/g or more, and even more preferably 15 m²/g or more. The BET specific surface area of the abrasives is preferably 250 m²/g or less, more preferably 90 m²/g or less, even more preferably 50 m²/g or less, and particularly preferably 25 m²/g or less. When abrasives having a BET specific surface area within the range are used, a high polishing removal rate can be achieved, and a polished object has a flatter and smoother surface.

The BET specific surface area of abrasives can be determined, for example, by using FlowSorb II 2300 manufactured by Micromeritics. As the gas adsorbed onto abrasives, nitrogen gas (N₂), argon (Ar), krypton (Kr), or the like can be used.

The content of the abrasives in the polishing composition according to the embodiment is not specifically limited. When the abrasives are alumina, the content is preferably 0.1% by mass or more, more preferably 1% by mass or more, and even more preferably 3% by mass or more. When the abrasives are silica, the content is preferably 0.1% by mass or more, more preferably 1% by mass or more, and even more preferably 3% by mass or more. When the content of the abrasives is within the range, a high polishing removal rate can be achieved.

The content of the abrasives in the polishing composition according to the embodiment is preferably 40% by mass or less, more preferably 20% by mass or less, and even more preferably 15% by mass or less when the abrasives are alumina. When the abrasives are silica, the content is preferably 40% by mass or less, more preferably 30% by mass or less, and even more preferably 25% by mass or less. When the content of the abrasives is within the range, scratches on a polished object can be reduced. In addition, the cost of the polishing composition can be suppressed.

4. pH of Polishing Composition

The polishing composition of the embodiment may have any pH, but the pH is preferably 13 or less and more preferably 12 or less. The polishing composition of the embodiment preferably has a pH of 2 or more and more preferably 3 or more. When the pH is within the range, a high polishing removal rate can be achieved. A polishing composition having a pH within the range is relatively safe and thus can be handled more safely.

The polishing composition according to the embodiment preferably has a pH of 7 or less and more preferably less than 7 (i.e., more preferably acidic).

When the abrasives are alumina and the polishing composition has a pH of less than 7, the abrasives have a positive zeta potential, and thus the abrasives easily adsorb to the surface of an object to be polished having a negative zeta potential. This improves the polishing removal rate. The abrasives have a positive zeta potential, and thus the abrasives repel each other and are difficult to aggregate. This improves the dispersion stability of the abrasives.

The pH of the polishing composition according to the embodiment may be adjusted by a pH adjuster as an additive. The pH adjuster will be specifically described later.

5. Water

The polishing composition according to the embodiment is a slurry containing abrasives, a surfactant, and water. Water functions as a dispersion medium or a solvent for dispersing or dissolving various components (such as abrasives, a surfactant, and additives) in the polishing composition. With the water, one or more organic solvents may be mixed.

From the viewpoint of preventing interference of the action of each component included in the polishing composition according to the embodiment, a water containing as few impurities as possible is preferably used. Specifically, pure water or ultrapure water prepared by removing impurity ions by ion exchange resins and then removing contaminants through filters or distilled water is preferably used.

The water content in the polishing composition is not specifically limited, but may be 40% by mass or more, and is more preferably 50% by mass or more and even more preferably 60% by mass or more (for example, 70% by mass or more). When a mixed solvent of water and a solvent other than water is used as the dispersion medium or the solvent, the ratio of water and the solvent other than water may be 100:0 to 50:50 or may be 99:1 to 60:40.

6. Additives

The polishing composition according to the embodiment may further contain additives other than the surfactant as needed in order to improve the performance. As the additive, a known additive contained in a typical polishing composition can be used. For example, various additives such as a pH adjuster, an oxidant, a polishing removal accelerator, a water-soluble polymer, a chelating agent, a dispersion assistant, an antiseptic agent, and an antifungal agent may be added.

6-1 pH Adjuster

To the polishing composition according to the embodiment, a pH adjuster may be added in order to adjust the pH to an intended value as needed. pH adjusters may be used singly or in combination of two or more of them. As the pH adjuster, a known acid, a base, or a salt of them may be used.

Specific examples of the acid usable as the pH adjuster include inorganic acids such as hydrochloric acid, sulfuric acid, nitric acid, hydrofluoric acid, boric acid, carbonic acid, hypophosphorous acid, phosphorous acid, and phosphoric acid; and organic acids such as formic acid, acetic acid, propionic acid, butyric acid, valeric acid, 2-methylbutyratic acid, n-hexanoic acid, 3,3-dimethylbutyric acid, 2-ethylbutyric acid, 4-methylpentanoic acid, n-heptanoic acid, 2-methylhexanoic acid, n-octanoic acid, 2-ethylhexanoic acid, benzoic acid, glycolic acid, salicylic acid, glyceric acid, oxalic acid, malonic acid, succinic acid, glutaric acid, adipic acid, pimelic acid, maleic acid, phthalic acid, malic acid, tartaric acid, citric acid, lactic acid, diglycolic acid, 2-furancarboxylic acid, 2,5-furandicarboxylic acid, 3-furancarboxylic acid, 2-tetrahydrofurancarboxylic acid, methoxyacetic acid, methoxyphenylacetic acid, and phenoxyacetic acid.

When an inorganic acid is used as the pH adjuster, sulfuric acid, nitric acid, hydrochloric acid, phosphoric acid, and the like are preferred from the viewpoint of improving the polishing removal rate. When an organic acid is used as the pH adjuster, glycolic acid, succinic acid, maleic acid, citric acid, tartaric acid, malic acid, gluconic acid, itaconic acid, and the like are preferred.

Examples of the base usable as the pH adjuster include amines such as an aliphatic amine and an aromatic amine, organic bases such as quaternary ammonium hydroxide, hydroxides of alkali metals, such as potassium hydroxide, hydroxides of alkaline earth metals, and ammonia. Of these bases, potassium hydroxide and ammonia are preferred from the viewpoint of availability.

In place of the acid or in combination with the acid, salts such as an ammonium salt of the above acid and an alkali metal salt may be used as the pH adjuster. In particular, when a salt of a weak acid and a strong base, a salt of a strong acid and a weak base, or a salt of a weak acid and a weak base is used, a pH buffer action is expected, and when a salt of a strong acid and a strong base is used in a small amount, not only the pH but also the electrical conductivity can be adjusted.

The amount of the pH adjuster is not specifically limited and can be appropriately adjusted such that the polishing composition has an intended pH.

6-2 Oxidant

To the polishing composition according to the embodiment, an oxidant may be added as needed in order to oxidize the surface of an object to be polished. The oxidant functions to oxidize the surface of an object to be polished, and adding an oxidant to a polishing composition improves the polishing removal rate of the polishing composition.

Examples of the usable oxidant include a peroxide, nitric acid, and potassium permanganate. Specific examples of the peroxide include hydrogen peroxide, peracetic acid, a percarbonate, urea peroxide, a perchlorate, and a persulfate (such as sodium persulfate, potassium persulfate, and ammonium persulfate).

6-3 Polishing Removal Accelerator

To the polishing composition, a polishing removal accelerator may be added. The polishing removal accelerator functions to chemically polish an object to be polished and can affect the surface of an object to be polished to markedly improves the processing efficiency. Polishing removal accelerators may be used singly or in combination of two or more of them.

Of the polishing removal accelerators, an aluminum salt of a monovalent acid is preferred, and has a function as a polishing removal accelerator and a function of improving the face quality of the polished face of a polished object. Preferred examples of the aluminum salt of a monovalent acid include aluminum nitrate (Al(NO₃)₃) and aluminum chloride (AlCl₃).

The content of the aluminum salt of a monovalent acid in the polishing composition is preferably 0.01% by mass or more, more preferably 2% by mass or more, even more preferably 4% by mass or more, particularly preferably more than 4% by mass, and most preferably 5% by mass or more from the viewpoint of more reliably improving the polishing performance of the polishing composition.

Meanwhile, even when the aluminum salt of a monovalent acid is contained in a large amount, the performance is not greatly improved, and such a condition is disadvantageous in cost. Hence, the content of the aluminum salt of a monovalent acid in the polishing composition is preferably 15% by mass or less. When the aluminum salt of a monovalent acid has hydration water, such a content excludes the hydration water.

The polishing composition according to the embodiment may contain a polishing removal accelerator other than aluminum nitrate or aluminum chloride. Examples of the polishing removal accelerator other than aluminum nitrate or aluminum chloride include inorganic acids, organic acids, and salts of these acids.

Specific examples of the inorganic acid include phosphoric acid, nitric acid, sulfuric acid, hydrochloric acid, hypophosphorous acid, phosphonic acid, boric acid, and sulfamic acid.

Specific examples of the organic acid include citric acid, maleic acid, malic acid, glycolic acid, succinic acid, itaconic acid, malonic acid, iminodiacetic acid, gluconic acid, lactic acid, mandelic acid, tartaric acid, crotonic acid, nicotinic acid, acetic acid, adipic acid, formic acid, oxalic acid, propionic acid, valeric acid, caproic acid, caprylic acid, capric acid, cyclohexanecarboxylic acid, phenylacetic acid, benzoic acid, crotonic acid, methacrylic acid, glutaric acid, fumaric acid, phthalic acid, isophthalic acid, terephthalic acid, glycolic acid, tartronic acid, glyceric acid, hydroxybutyric acid, hydroxyacetic acid, hydroxybenzoic acid, salicylic acid, isocitric acid, methylenesuccinic acid, gallic acid, ascorbic acid, nitroacetic acid, oxaloacetic acid, glycine, alanine, glutamic acid, aspartic acid, valine, leucine, isoleucine, serine, threonine, cysteine, methionine, phenylalanine, tryptophan, tyrosine, proline, cystine, glutamine, asparagine, lysine, arginine, nicotinic acid, picolinic acid, methyl acid phosphate, ethyl acid phosphate, ethyl glycol acid phosphate, isopropyl acid phosphate, phytic acid, 1-hydroxyethylidene-1,1-diphosphonic acid, aminotri(methylene phosphonic acid), ethylenediamine tetra(methylene phosphonic acid), diethylenetriamine penta(methylene phosphonic acid), ethane-1,1-diphosphonic acid, ethane-1,1,2-triphosphonic acid, ethane-1-hydroxy-1,1-diphosphonic acid, ethanehydroxy-1,1,2-triphosphonic acid, ethane-1,2-dicarboxy-1,2-diphosphonic acid, methanehydroxyphosphonic acid, 2-phosphonobutane-1,2-dicarboxylic acid, 1-phosphonobutane-2,3,4-tricarboxylic acid, α-methylphosphonosuccinic acid, aminopoly(methylenephosphonic acid), methanesulfonic acid, ethanesulfonic acid, aminoethanesulfonic acid, benzenesulfonic acid, p-toluenesulfonic acid, and 2-naphthalenesulfonic acid.

Examples of the salts of these acids include metal salts of the above inorganic acid or the organic acid (such as alkali metal salts including a lithium salt, a sodium salt, and a potassium salt), ammonium salts (such as quaternary ammonium salts including a tetramethylammonium salt and a tetraethylammonium salt), and alkanolamine salts (such as a monoethanolamine salt, a diethanolamine salt, and a triethanolamine salt).

Specific examples of the salt include alkali metal phosphates and alkali metal hydrogen phosphates such as tripotassium phosphate, dipotassium hydrogen phosphate, potassium dihydrogen phosphate, trisodium phosphate, disodium hydrogen phosphate, and sodium dihydrogen phosphate. Specific examples of the salt further include alkali metal salts of the above exemplified organic acids, alkali metal salts of glutamic acid diacetic acid, alkali metal salts of diethylenetriaminepentaacetic acid, alkali metal salts of hydroxyethylethylenediaminetriacetic acid, and alkali metal salts of triethylenetetraminehexaacetic acid. Examples of the alkali metal in the alkali metal salts include lithium, sodium, and potassium.

6-4 Water-Soluble Polymer

To the polishing composition according to the embodiment, a water-soluble polymer may be added. The water-soluble polymer may be any type, and examples include polyalkylene oxide alkyl ether, glycols such as ethylene glycol, diethylene glycol, triethylene glycol, polyethylene glycol, propylene glycol, dipropylene glycol, tripropylene glycol, and polypropylene glycol, pyrrolidone compounds having a 2-pyrrolidone group (such as poly-N-vinylpyrrolidone), and caprolactam compounds. Examples of the water-soluble polymer further include cellulose derivatives, starch derivatives, polyacrylic acid (or a salt thereof), polyacrylamide, polyvinyl alcohol, polyethyleneimine, and polyalkylene oxide. Of these water-soluble polymers, a pyrrolidone compound having a 2-pyrrolidone group and a caprolactam compound are more preferred.

The weight average molecular weight of the water-soluble polymer is preferably 3,000 or more, more preferably 5,000 or more, even more preferably 10,000 or more, and particularly preferably 30,000 or more. A water-soluble polymer having such a weight average molecular weight has a technical effect of improving the slurry dispersion stability. The weight average molecular weight of the water-soluble polymer is preferably 500,000 or less, more preferably 300,000 or less, and even more preferably 100,000 or less. A water-soluble polymer having such a weight average molecular weight has a technical effect of improving the stability.

When contained together with an aluminum salt of a monovalent acid in the polishing composition, the pyrrolidone compound having a 2-pyrrolidone group effectively functions to accelerate resin polishing. The pyrrolidone compound having a 2-pyrrolidone group may be any type, and examples include N-octyl-2-pyrrolidone, N-dodecyl-2-pyrrolidone, N-methyl-2-pyrrolidone, N-ethyl-2-pyrrolidone, N-cyclohexyl-2-pyrrolidone, N-hydroxyethyl-2-pyrrolidone, n-butyl-2-pyrrolidone, n-hexyl-2-pyrrolidone, N-decyl-2-pyrrolidone, N-octadecyl-2-pyrrolidone, N-hexadecyl-2-pyrrolidone, poly-N-vinylpyrrolidone, and a copolymer of poly-N-vinylpyrrolidone. These pyrrolidone compounds having a 2-pyrrolidone group may be used singly or in combination of two or more of them.

As the pyrrolidone compound having a 2-pyrrolidone group, poly-N-vinylpyrrolidone (hereinafter also called “PVP”) is preferred. PVP preferably has a weight average molecular weight of 3,000 or more and more preferably 10,000 or more. PVP preferably has a weight average molecular weight of 60,000 or less and more preferably 50,000 or less. PVPs having a weight average molecular weight within the range are easily available from various product suppliers.

The content of the pyrrolidone compound in the polishing composition according to the embodiment is preferably 0.01% by mass or more, more preferably 0.05% by mass or more, and even more preferably 0.1% by mass or more. The content of the pyrrolidone compound in the polishing composition according to the embodiment is preferably 5% by mass or less, more preferably 2% by mass or less, and even more preferably 1% by mass or less.

The caprolactam compound is a nitrogen-containing organic compound called ε-caprolactam and can be used in place of the pyrrolidone compound. The content of the caprolactam compound in the polishing composition according to the embodiment is preferably 0.01% by mass or more, more preferably 0.05% by mass or more, and even more preferably 0.1% by mass or more. The content of the caprolactam compound in the polishing composition according to the embodiment is preferably 5% by mass or less, more preferably 2% by mass or less, and even more preferably 1% by mass or less.

6-5 Chelating Agent

To the polishing composition according to the embodiment, a chelating agent may be added as needed in order to prevent metal contamination of an object to be polished by capturing metal impurity components in a polishing system and forming a complex. Specific examples of the chelating agent include a carboxylic acid, an amine, an organic phosphonic acid, and an amino acid.

6-6 Dispersion Assistant

To the polishing composition according to the embodiment, a dispersion assistant may be added as needed in order to facilitate redispersion of abrasive aggregates. Specific examples of the dispersion assistant include condensed phosphates such as a pyrophosphate and a hexametaphosphate.

6-7 Antiseptic Agent, Antifungal Agent

To the polishing composition according to the embodiment, an antiseptic agent or an antifungal agent may be added as needed. Examples of the antiseptic agent or the antifungal agent include isothiazoline antiseptic agents such as 2-methyl-4-isothiazolin-3-one and 5-chloro-2-methyl-4-isothiazolin-3-one, p-hydroxybenzoate esters, and phenoxyethanol.

7. Method for Producing Polishing Composition

The polishing composition according to the embodiment may be produced by any method and can be produced by stirring and mixing abrasives, the above acetylene compound, and various optional additives in water. These components may be mixed at any temperature, but the temperature is preferably 10° C. or more and 40° C. or less, or the mixture may be heated to improve dissolving rates. The mixing time is not specifically limited.

The polishing composition according to the embodiment may be a one-agent type or may be a multi-agent type including a two-agent type, in which some or all of the components in the polishing composition are mixed at any ratio. The polishing composition according to the embodiment may be prepared by diluting a liquid concentrate of the polishing composition with water, for example, 10-fold or more. When the polishing composition is a two-agent type, two material compositions as the materials of the polishing composition may be mixed and diluted in any order. For example, one material composition may be diluted with water and then may be mixed with the other material composition, both the material compositions may be mixed and diluted with water at the same time, or both the material compositions may be mixed and then may be diluted with water.

8. Polishing Apparatus and Polishing Method

A resin object to be polished may be polished with the polishing composition according to the embodiment by any method in any conditions, and a method and conditions suitable for polishing an object to be polished can be appropriately selected from typical polishing methods and typical conditions. As the polishing apparatus, a typical single-side polishing apparatus or a double-side polishing apparatus can be used.

When a single-side polishing apparatus is used to perform polishing, a holding tool called a carrier is used to hold an object to be polished; a polishing composition is interposed between the object to be polished and a polishing pad; a surface plate with the polishing pad is pressed against one face of the object to be polished; and the surface plate is rotated to polish one face of the object to be polished.

When a double-side polishing apparatus is used to perform polishing, a carrier is used to hold an object to be polished; a polishing composition is interposed between the object to be polished and polishing pads; surface plates with the polishing pads are pressed against the respective faces of the object to be polished; and the polishing pads and the object to be polished are rotated in counter directions to polish the respective faces of the object to be polished.

Regardless of which polishing apparatus is used, an object to be polished is polished by the physical action of friction between a polishing pad and a polishing composition and the object to be polished and the chemical action of a polishing composition on the object to be polished.

The polishing pad may be any type, and various polishing pads different in physical properties such as material, thickness, and hardness can be used. Examples of the material of the polishing pad include polyurethane, an epoxy resin, a nonwoven fabric, and a suede. The polishing pad may have grooves so formed as to hold a polishing composition.

### EXAMPLES

The present invention will be described more specifically with reference to examples and comparative examples.

### Example 1

Abrasives, a nonionic surfactant, and water were mixed, and then a pH adjuster (nitric acid or an aqueous potassium hydroxide) was added to adjust the pH at 3.2, giving a polishing composition of Example 1.

As the abrasives, an alumina having a D50 of 0.7 μm was used. The content of the abrasives in the polishing composition was 15% by mass. As the surfactant, an acetylene compound represented by Chemical Formula (2) was used. The acetylene compound had an HLB value of 8. The HLB value can be controlled by the numerical values of p and q in Chemical Formula (2). The content of the surfactant in the polishing composition was 0.05% by mass.

Next, the above polishing composition was used to polish the surface of a resin object to be polished. The object to be polished was a plate part formed from polytetrafluoroethylene (PTFE). The polishing conditions will be described below.

Polishing apparatus: single-side polishing apparatus, EJ-380IN, manufactured by Engis (a surface plate diameter of 380 mm)

Polishing pad: a suede polishing pad (N17(HD)NX_202U manufactured by Fujibo Ehime Co., Ltd.)

Polishing pressure: 9.8 kPa (100 gf/cm²)

Surface plate rotation speed: 80 min⁻¹

Polishing removal rate (linear velocity): 95.5 m/min

Polishing time: 5 min

Supply flow rate of polishing composition: 15 mL/min

After the completion of polishing, the surface roughness Ra and the static contact angle of the polished face of the polished object were determined. The surface roughness Ra on the polished face of the polished object was determined by using a measurement apparatus, Laser Microscope VK-X200 manufactured by KEYENCE CORPORATION in a condition of a viewing angle of 284×213 μm. The static contact angle on the polished face of the polished object was determined by using a portable contact angle meter, PG-X+ manufactured by MATSUBO Corporation (a water dropping amount of 40 μL). The thickness of the object to be polished and the thickness of the polished object were determined, and the difference in thickness was divided by the polishing time to give the polishing removal rate. Table 1 shows the results.

TABLE 1

| | | | | | | Polishing | Surface | |
|---|---|---|---|---|---|---|---|---|
| | | Components of | | | | removal | roughness | Contact |
| | | polishing | Surfactant | | | rate | Ra | angle |
| | Resin | composition | Type | HLB value | Content ¹⁾ | (μm/min) | (nm) | (degrees) |
| Comp. Ex. 1 | PTFE | Alumina | — | — | — | 0.37 | 21 | 102 |
| Comp. Ex. 2 | | Surfactant | Polyoxyethylene alkyl ether | 8 | 0.05 | 0.31 | 23 | 52 |
| Comp. Ex. 3 | | | Polyoxyalkylene alkyl ether | 12.6 | 0.05 | 0.35 | 22 | 72 |
| Comp. Ex. 4 | | | Polyoxyalkylene alkyl ether | 16 | 0.05 | 0.42 | 22 | 77 |
| Ex. 1 | | | Acetylene compound of | 8 | 0.05 | 0.40 | 20 | 51 |
| Ex. 2 | | | Chemical Formula (2) | 13 | 0.05 | 0.43 | 19 | 60 |
| Ex. 3 | | | | 17 | 0.05 | 0.48 | 19 | 75 |
| Comp. Ex. 5 | | Alumina | — | — | — | 0.70 | 19 | 91 |
| Comp. Ex. 6 | | Surfactant | Polyoxyethylene alkyl ether | 8 | 0.05 | 0.72 | 21 | 49 |
| Comp. Ex. 7 | | Aluminum | Polyoxyalkylene alkyl ether | 16 | 0.05 | 0.67 | 20 | 74 |
| Ex. 4 | | nitrate | Acetylene compound of | 8 | 0.05 | 0.80 | 17 | 49 |
| Ex. 5 | | PVP | Chemical Formula (2) | 17 | 0.05 | 0.83 | 18 | 71 |
| Comp. Ex. 8 | PMMA | | — | — | — | 9.50 | 7 | 62 |
| Comp. Ex. 9 | | | Polyoxyethylene alkyl ether | 8 | 0.05 | 9.40 | 9 | 48 |
| Ex. 6 | | | Acetylene compound of | 8 | 0.05 | 10.67 | 6 | 50 |
| | | | Chemical Formula (2) | | | | | |
| Comp. Ex. 10 | PC | | — | — | — | 1.40 | 9 | 67 |
| Comp. Ex. 11 | | | Polyoxyethylene alkyl ether | 8 | 0.05 | 1.34 | 9 | 54 |
| Ex. 7 | | | Acetylene compound of | 8 | 0.05 | 1.69 | 8 | 57 |
| | | | Chemical Formula (2) | | | | | |
| Ex. 8 | PTFE | | Acetylene compound of | 8 | 0.01 | 0.75 | 18 | 78 |
| Ex. 9 | | | Chemical Formula (2) | 8 | 0.1 | 0.71 | 18 | 42 |

¹⁾ In terms of % by mass.

### Examples 2 and 3

A polishing composition was produced in a similar manner to that in Example 1 except that a different nonionic surfactant was used, and the polishing composition was used to polish an object to be polished in a similar manner to that in Example 1. The used surfactant was an acetylene compound represented by Chemical Formula (2) but differed from that used in Example 1 in the numerical values of p and q in Chemical Formula (2). Accordingly, the surfactants had different HLB values. Table 1 shows the results.

### Comparative Example 1

A polishing composition was produced in a similar manner to that in Example 1 except that no surfactant was used, and the polishing composition was used to polish an object to be polished in a similar manner to that in Example 1. Table 1 shows the results.

### Comparative Examples 2 to 4

A polishing composition was produced in a similar manner to that in Example 1 except that a different nonionic surfactant was used, and the polishing composition was used to polish an object to be polished in a similar manner to that in Example 1. The surfactant used in Comparative Example 2 was polyoxyethylene alkyl ether, and the surfactants used in Comparative Example 3 and 4 were polyoxyalkylene alkyl ethers. Between Comparative Example 3 and Comparative Example 4, the surfactants had different HLB values. Table 1 shows the results.

### Example 4

Abrasives, a nonionic surfactant, aluminum nitrate-nonahydrate (Al(NO₃)₃·9H₂O), PVP, and water were mixed, and then a pH adjuster (nitric acid or an aqueous potassium hydroxide) was added to adjust the pH at 3.2, giving a polishing composition of Example 4.

As the abrasives, the same alumina as in Example 1 was used. The content of the abrasives in the polishing composition was 15% by mass. As the surfactant, the same acetylene compound as in Example 1 was used. The content of the surfactant in the polishing composition was 0.05% by mass. The content of aluminum nitrate-nonahydrate in the polishing composition was 10% by mass. The content of PVP in the polishing composition was 0.05% by mass.

Next, the polishing composition of Example 4 was used to polish the surface of a resin object to be polished. The object to be polished was a plate part formed from polytetrafluoroethylene. The polishing conditions were the same as in Example 1. After the completion of polishing, the surface roughness Ra and the static contact angle of the polished face of the polished object were determined in a similar manner to that in Example 1, and the polishing removal rate was calculated. Table 1 shows the results.

### Example 5

A polishing composition was produced in a similar manner to that in Example 4 except that a different nonionic surfactant was used, and an object to be polished was polished in a similar manner to that in Example 4. The used surfactant was the same acetylene compound as in Example 3. Table 1 shows the results.

### Comparative Example 5

A polishing composition was produced in a similar manner to that in Example 4 except that no surfactant was used, and an object to be polished was polished in a similar manner to that in Example 4. Table 1 shows the results.

### Comparative Examples 6 and 7

A polishing composition was produced in a similar manner to that in Example 4 except that a different nonionic surfactant was used, and an object to be polished was polished in a similar manner to that in Example 4. The surfactant used in Comparative Example 6 was the same as in Comparative Example 2, and the surfactant used in Comparative Example 7 was the same as in Comparative Example 4. Table 1 shows the results.

### Example 6

A polishing composition was produced in a similar manner to that in Example 4, and an object to be polished was polished in a similar manner to that in Example 4 except that the object to be polished was a plate part formed from polymethyl methacrylate (PMMA). Table 1 shows the results.

### Comparative Example 8

A polishing composition was produced in a similar manner to that in Comparative Example 5, and an object to be polished was polished in a similar manner to that in Example 4 except that the object to be polished was a plate part formed from PMMA. Table 1 shows the results.

### Comparative Example 9

A polishing composition was produced in a similar manner to that in Comparative Example 6, and an object to be polished was polished in a similar manner to that in Example 4 except that the object to be polished was a plate part formed from PMMA. Table 1 shows the results.

### Example 7

A polishing composition was produced in a similar manner to that in Example 4, and an object to be polished was polished in a similar manner to that in Example 4 except that the object to be polished was a plate part formed from polycarbonate (PC). Table 1 shows the results.

### Comparative Example 10

A polishing composition was produced in a similar manner to that in Comparative Example 5, and an object to be polished was polished in a similar manner to that in Example 4 except that the object to be polished was a plate part formed from PC. Table 1 shows the results.

### Comparative Example 11

A polishing composition was produced in a similar manner to that in Comparative Example 6, and an object to be polished was polished in a similar manner to that in Example 4 except that the object to be polished was a plate part formed from PC. Table 1 shows the results.

### Examples 8 and 9

A polishing composition was produced in a similar manner to that in Example 4 except that the surfactant was contained at a different content, and an object to be polished was polished in a similar manner to that in Example 4. Table 1 shows the results.

As apparent from the results shown in Table 1, the polishing removal rate was high in Examples 1 to 9. In addition, the polished face of the polished object had a small surface roughness Ra, and the surface of a resin object to be polished was able to be polished into a flat and smooth surface.

In contrast, in Comparative Examples 1 to 11, the polishing removal rate was lower, and the polished face had a lower surface roughness Ra than in Examples.

1. A polishing composition used to polish a resin object to be polished, the polishing composition comprising:
abrasives;
a surfactant; and
water, wherein
the surfactant includes an acetylene compound having a carbon-carbon triple bond and represented by Chemical Formula (1): 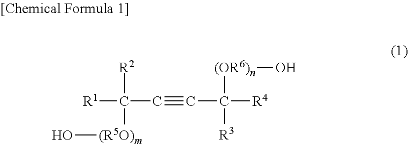
in Chemical Formula (1), R¹, R², R³, and R⁴ are each independently a hydrogen atom or a substituted or unsubstituted alkyl group having 1 or more and 20 or less carbon atoms; R⁵ and R⁶ are each independently a substituted or unsubstituted alkylene group having 1 or more and 5 or less carbon atoms; m is an integer of 1 or more; n is an integer of 0 or more; and m+n is 50 or less.

2. The polishing composition according to claim 1, wherein the abrasives are at least one of alumina and silica.

3. The polishing composition according to claim 1, wherein the abrasives are alumina.

4. The polishing composition according to claim 1, wherein the acetylene compound has an HLB value of 10 or more and 18 or less.

5. The polishing composition according to claim 1, wherein the polishing composition has a pH of 7 or less.

6. The polishing composition according to claim 1, further comprising an aluminum salt of a monovalent acid; and a pyrrolidone compound having a 2-pyrrolidone group or a caprolactam compound.

7. The polishing composition according to claim 1, wherein the resin is a highly water repellent resin having a contact angle of 900 or more.

8. The polishing composition according to claim 1, wherein the resin is a resin having low hardness and high elasticity and having a Rockwell hardness HRM of 65 or less and a tensile elastic modulus of 2.8 GPa or less.

9. A polishing method comprising polishing a resin object to be polished with the polishing composition according to claim 1.

10. The polishing composition according to claim 2, wherein the acetylene compound has an HLB value of 10 or more and 18 or less.

11. The polishing composition according to claim 3, wherein the acetylene compound has an HLB value of 10 or more and 18 or less.

12. The polishing composition according to claim 2, wherein the polishing composition has a pH of 7 or less.

13. The polishing composition according to claim 3, wherein the polishing composition has a pH of 7 or less.

14. The polishing composition according to claim 4, wherein the polishing composition has a pH of 7 or less.

15. The polishing composition according to claim 2, further comprising an aluminum salt of a monovalent acid; and a pyrrolidone compound having a 2-pyrrolidone group or a caprolactam compound.

16. The polishing composition according to claim 3, further comprising an aluminum salt of a monovalent acid; and a pyrrolidone compound having a 2-pyrrolidone group or a caprolactam compound.

17. The polishing composition according to claim 4, further comprising an aluminum salt of a monovalent acid; and a pyrrolidone compound having a 2-pyrrolidone group or a caprolactam compound.

18. The polishing composition according to claim 5, further comprising an aluminum salt of a monovalent acid; and a pyrrolidone compound having a 2-pyrrolidone group or a caprolactam compound.

19. A polishing method comprising polishing a resin object to be polished with the polishing composition according to claim 2.

20. A polishing method comprising polishing a resin object to be polished with the polishing composition according to claim 3.
